(19) United States
(12) Patent Application Publication
(10) Pub. No.: US 2006/0238469 A1
(43) Pub. Date: Oct. 26, 2006

(54) Display device

(76) Inventors: Mark Thomas Johnson, Eindhoven (NL); Sander Jurgen Roosendaal, Eindhoven (NL); Galileo June Adeva Destura, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/551,887

(22) PCT Filed: Mar. 26, 2004
(86) PCT No.: PCT/IB04/50347

§ 371 Date: Oct. 4, 2005

(30) Foreign Application Priority Data
Apr. 7, 2003 (EP) 03100910.3

(51) Int. Cl. G09G 3/36

(52) U.S. Cl. 345/87

(57) ABSTRACT

The invention relates to a display device comprising a liquid crystal material between a first substrate provided with row or selection electrodes and a second substrate provided with column or data electrodes, in which overlapping parts of the row and column electrodes define pixels, and drive means for driving the column electrodes in conformity with an image to be displayed. Such display devices are used in, for example portable apparatuses such as laptop computers, notebook computers and telephones.

The invention relates to a display device comprising a liquid crystal material between a first substrate provided with row or selection electrodes and a second substrate provided with column or data electrodes, in which overlapping parts of the row and column electrodes define pixels, and drive means for driving the column electrodes in conformity with an image to be displayed. Such display devices are used in, for example portable apparatuses such as laptop computers, notebook computers and telephones.

Passive matrix displays of this type are generally known. In such a display m is the number of rows to be maximally multiplexed with a maximum contrast determined by the threshold voltage Vₜₕ and the saturation voltage Vₛₐₜ of the liquid crystal material. As described in the Alt & Pleshko analysis (IEEE Trans. El. Dev., Vol ED-21, No. 2, Febr. 1974, pp. 146-155), this maximum number of rows is equal to:

$$m = \frac{{( {V}_{th}^{2} + {V}_{sat}^{2} )}^{2}}{{( {V}_{sat}^{2} - {V}_{th}^{2} )}^{2}}$$

In an article by T. N. Ruckmongathan et al. “A New Addressing Technique for Fast Responding STN LCDs”, Japan Display 92, pp. 65-68, a group of L rows is driven with mutually orthogonal signals. Since a set of orthogonal signals, such as Walsh functions, consists of a number of functions which is a power of 2, hence 2^{S}, L is preferably chosen to be as equal as possible thereto, hence generally L=2^{S}, or L=2^{S}−1. The orthogonal row signals Fᵢ(t) are preferably square-shaped and consist of the voltages +F and −F, while the row voltage is equal to zero outside the selection period. The elementary voltage pulses of which the orthogonal signals are composed, are regularly distributed in the field period. Thus, the pixels are then excited 2^{S} or (2^{S}−1) times per field period with regular intervals instead of once per field period (Multiple row addressing).

Notably in applications in display devices built into portable apparatuses (mobile telephone, laptop computers) the aim is not only to drive these apparatuses with a minimal energy but also to introduce further functions such as sensing and activation of the display device (singing display).

It is an object of the invention to provide a display device of the type described above in which a drive voltage is chosen to be as favorable as possible and in which these functions can be combined.

To this end the display device comprises drive means for driving the column electrodes and the row electrodes by which drive means the column electrodes are selected during a selection time t, and further drive means for driving row electrodes or column electrodes in conformity with a further non-image application during a period tₐₚₚ, in which the multiplexibility m of the liquid crystal is larger than (N. t₁+tₐₚₚ)/t₁.

One embodiment comprises drive means for driving the column electrodes and drive means for driving M row electrodes in conformity with a further non-image application, in which the multiplexibility m of the liquid crystal is larger than (M/n+N) in which n is the number of simultaneously driven row electrodes during said further non-image application.

Especially when the driving signals for said M row electrodes and the corresponding column signals during selection of said M row electrodes (or the extra drive means in general) result in a zero RMS voltage the image displayed is not influenced by the other functions.

These and other aspects invention will now be elucidated with reference to some non-restricting embodiments and the drawing in which

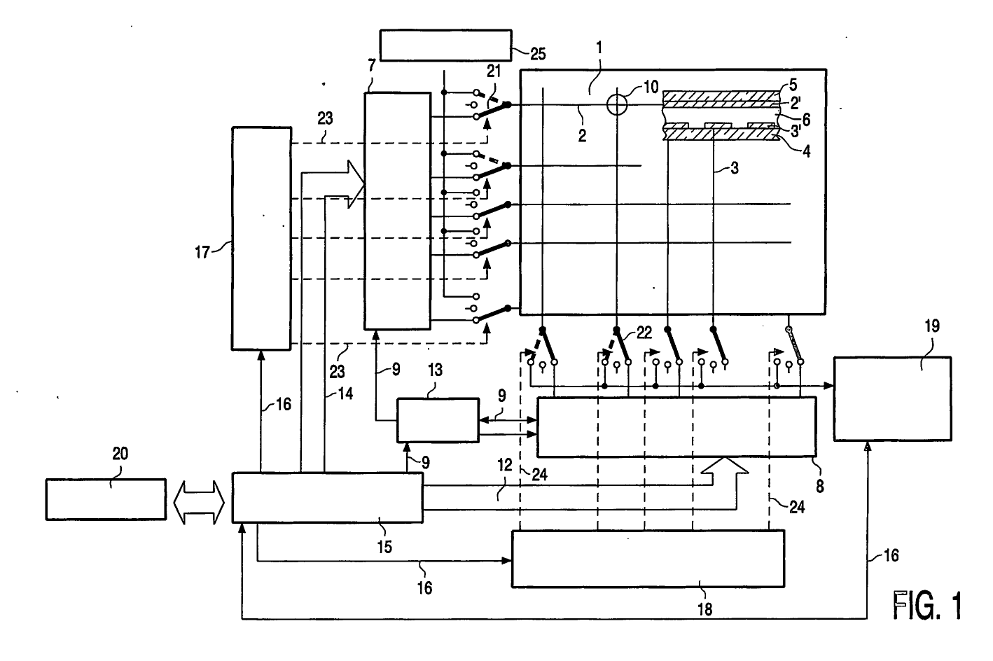

FIG. 1 shows diagrammatically a display device in which the invention is used,

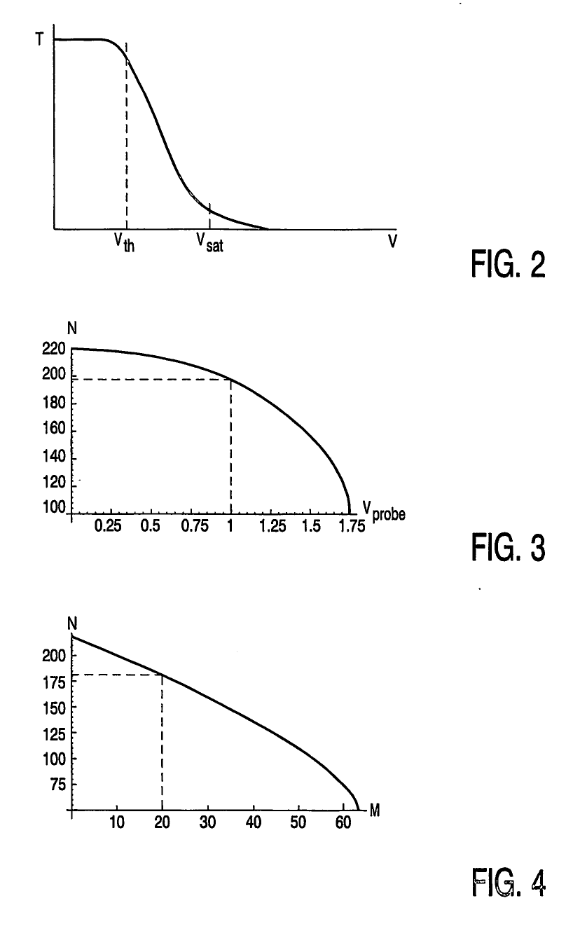

FIG. 2 shows a transmission/voltage characteristic curve of a liquid crystal material to be used in the device of FIG. 1,

FIG. 3 shows the multiplexibility as a function of V_{probe} for a display with a certain liquid crystal material, while.

FIG. 4 shows the multiplexibility as a function of the probing time and

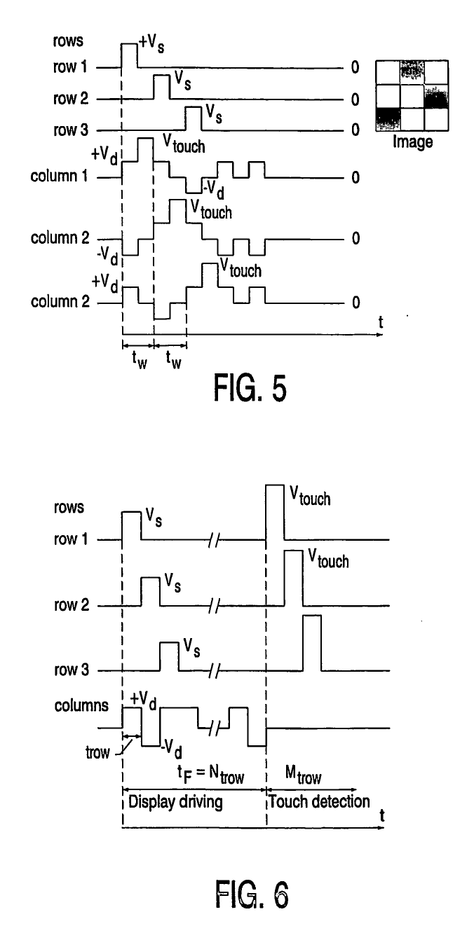

FIGS. 5-8 show different examples of driving schemes for a display device in which the invention is used.

FIG. 1 shows a display device with a matrix 1 of pixels 10 at the a of crossings of rows 2 and columns 3 which are provided as row electrodes 2′ and column electrodes 3′ on facing surfaces of substrates 4, 5, as can be seen in the cross-section shown in the matrix 1. The liquid crystal material 6 is present between the substrates. For the sake of simplicity, other elements, such as orientation layers, polarizers, etc. are omitted in the cross-section.

The row electrodes are (consecutively) selected by means of a row driver 7 while the column electrodes are provided with data via a data register 8. To this end, incoming data 12 and selection signals 14 are first processed, if necessary, in a (software) processor 15. Mutual synchronization between the row driver 7 and the data register 8 occurs via control lines 9 in the synchronization unit 13. The processor 15 also controls via control lines 16 switch control circuits 17, 18 and any further control circuit 19, dependent on an application as defined by block 20.

The row driver 7 in the situation shown provides selection signals having amplitude Vₛ to the rows 2. To this end switches 21 controlled by control circuit 17 via control lines 23 connect outputs of row driver 7 to the rows 2. At the same time the column driver 8 provides data signals having amplitude V_{d} to the columns 3. To this end switches 22 controlled by control circuit 18 via control lines 24 connect outputs of row driver 7 to the columns 3.

As discussed in the Alt & Pleshko analysis (IEEE Trans. El. Dev., Vol ED-21, No. 2, Febr. 1974, pp. 146-155) for a passive driven (S(uper)) T(wisted) N(ematic) L(iquid) C(rystal) D(isplay), the root-mean-square pixel voltage has to be higher than the saturation voltage (Vₛₐₜ) for dark pixels and lower than the threshold voltage (Vₜₕ) for bright pixels for a normally white display (or vice versa for a normally black display), see FIG. 2 which shows a transmission/voltage characteristic curve of a liquid crystal material to be used in such a normally white display. The root-mean-square average voltage over a frame time determines the pixel voltage. For a display with N lines, driven with a row voltage Vᵣ and a column voltage ±V_{c}, the average square pixel voltage is:

$${\overline{V}}_{pix}^{2} = \frac{1}{N} ( ( N - 1 ) {V}_{c}^{2} + {( {V}_{c} \pm {V}_{r} )}^{2} )$$

By solving the equations for Vₚᵢₓ=Vₜₕ and V=Vₚᵢₓ=Vₛₐₜ, expressions are found for V_{c} and Vᵣ and for the multiplexibility or the maximum number of lines which can be addressed viz.:

$${N}_{max} = \frac{{( {V}_{th}^{2} + {V}_{sat}^{2} )}^{2}}{{( {V}_{sat}^{2} - {V}_{th}^{2} )}^{2}} \qquad ( 1 )$$

According to the invention for a further function, indicated by block 25 in FIG. 1 different voltages can be applied via the switches 21 controlled by control circuit 17 via control lines 23 to electrodes 2. The further function may introduce voltages related to said further function (e.g. a probe function or activation of the full display device into vibration). If necessary different voltages can be applied simultaneously (either directly or by control of control circuit 19) via the switches 22, controlled by control circuit 18 via control lines 24, to electrodes 3. On the other hand the voltages for a probe function or activation of the full display may be applied to electrodes 3 only.

When using probe signals or activating signals only a part of the frame time is used for addressing the display. For a display with N lines and a line time of t_{row}, the total frame time is N t_{row}. When probing signals are present, this time will be (N+M) t_{row}, where it is assumed that the time needed for probing is M.t_{row}. (M can be understood as the number of sacrificed rows, in this case the number of rows used for probing). During the probing, each pixel senses an average square voltage V_{probe}². The average pixel voltage will now be:

$${\overline{V}}_{pix}^{2} = \frac{1}{N + M} ( ( N - 1 ) {V}_{c}^{2} + {( {V}_{c} \pm {V}_{r} )}^{2} + {MV}_{probe}^{2} )$$

Solving this for Vₚᵢₓ=Vₛₑₜ and Vₚᵢₓ=Vₜₕ, the row and column voltages are:

$${V}_{c} = \frac{1}{2} \sqrt{\frac{1}{N} ( \begin{matrix}- 2 {MV}_{probe}^{2} + ( M + N ) ( {V}_{sat}^{2} + {V}_{th}^{2} ) - \\ \sqrt{\begin{matrix}( - {N ( M + N )}^{2} {( {V}_{sat}^{2} - {V}_{th}^{2} )}^{2} + \\ {( - 2 {MV}_{probe}^{2} + ( M + N ) ( {V}_{sat}^{2} + {V}_{th}^{2} ) )}^{2} )\end{matrix}}\end{matrix} )} \\ {V}_{r} = \frac{- ( ( M + N ) ( {V}_{sat}^{2} - {V}_{th}^{2} ) )}{( \begin{matrix}2 \\ \sqrt{\frac{1}{N} ( \begin{matrix}- 2 {MV}_{probe}^{2} + ( M + N ) ( {V}_{sat}^{2} + {V}_{th}^{2} ) - \\ \sqrt{( \begin{matrix}- {N ( M + N )}^{2} {( {V}_{sat}^{2} + {V}_{th}^{2} )}^{2} + \\ {( \begin{matrix}- 2 {MV}_{probe}^{2} + \\ {( M + N )}^{2} ( {V}_{sat}^{2} + {V}_{th}^{2} )\end{matrix} )}^{2}\end{matrix} )}\end{matrix} )}\end{matrix} )} \qquad ( 2 )$$

The row voltages and column voltages in the absence of probing signals can be found by putting M=0 and are equal to those of the Alt & Pleshko analysis. The multiplexibility can be found by solving:
(−N(M+N)²(Vₛₐₜ²−Vₜₕ²)+(−2MV_{probe}²+(M+N)(Vₛₐₜ²+Vₜₕ²))²)=0

FIG. 3 shows the multiplexibility as a function of V_{probe} for a S(uper) T(wisted) N(ematic) L(iquid) C(rystal) D(isplay) with a multiplexibility of the liquid crystal material of 219 and a Vₜₕ=1V, Vₛₐₜ=1.07V. It shows that for a probing signal of 1V, a display with 194 lines can be driven. FIG. 4 shows the multiplexibility as a function of the probing time (expressed in M, the number of line addressing times needed for probing) for a V_{probe}=1V. So if 20 line times are needed for the probing signals a display with 180 lines can be driven.

In the calculations V_{probe}², the root-mean-square average value of the probing voltage at the picture element, is used and M, which means that M.t_{row} is a measure of the total amount of time spent for the probing during one frame. The probing may be spread over the frame time (e.g. probe every line immediately before or after it has been addressed) or in a block at the end of every frame.

The first possibility is shown in FIG. 5 in which during subsequent time periods t_{w} a picture element is selected (a signal Vₛ is applied to a row electrode, while a signal ±V_{d} is applied to a column electrode), while immediately after selection of row i (i=1,2,3 in this example) a signal V_{touch} is applied to column electrode i to electrodes 3, while the electrodes 2 stay at 0V. The probing of a touch action is performed by ways per se known in the art.

FIG. 6 shows an alternative driving schema in which touch detection occurs after writing N lines. M lines are selected (during a line selection time in this example) for probing of the touchingaction. Now the probing signal V_{touch} is applied to the row electrodes. The total time for probing is M.t_{row}, which in certain applications may be shortened by probing two or more lines simultaneously.

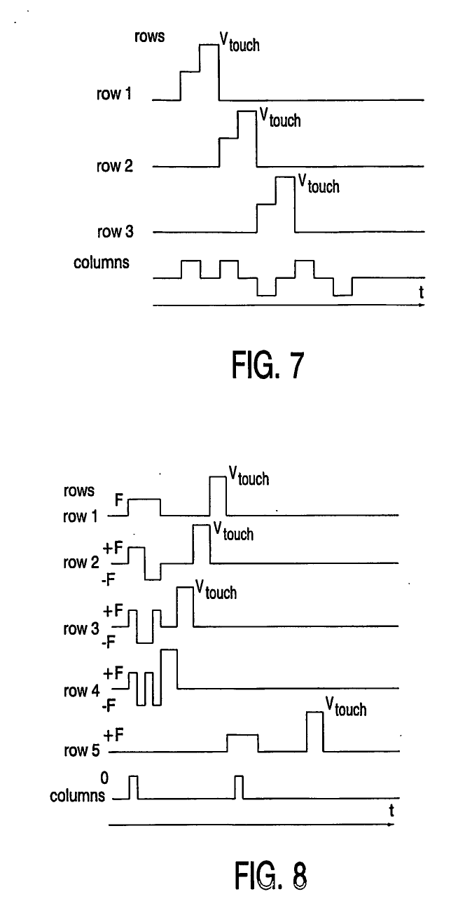

FIG. 7 shows an alternative to the driving signals of FIG. 5. Now immediately after selection of row i (i=1,2,3 in this example) a signal V_{touch} is applied to row electrode i while the electrodes 3 stay at 0V.

In another embodiment the row driver 7 comprises a row function generator implemented, for example as a ROM, for generating orthogonal signals Fᵢ(t) for driving the rows 2. Similarly as described in the article by Scheffer and Clifton, mentioned in the introductory part, row vectors are defined during each elementary time interval, which row vectors drive a group of p rows via the row driver. The row vectors are written into a row function register while information to be displayed is stored in an buffer memory and read as information vectors per elementary unit of time. Signals for the column electrodes 3 are obtained by multiplying the then valid values of the row vector and the information vector by each other during each elementary unit of time and by subsequently adding the obtained products. In this case, p rows are always driven simultaneously, in which p<M.

This method of driving does not change the multiplexibility m of the liquid crystal material. Adding the probing signals alters the row and column voltages needed for multiple row addressing in a different way than for single row addressing as described above, but the dependence of N on M and V_{probe} is the same as shown in FIG. 3.

For a display of N lines driven with p lines at a time, the row signals are given by the orthogonal functions Fᵢ (0<i<=p) with:

$$\begin{matrix}\frac{1}{T} {\int }_{0}^{T} {F}_{i} {F}_{j} ⅆ t = 0 ; i \neq j \\ = {F}^{2} ; i = j\end{matrix}$$

The column signal of column j is given by:

$${G}_{j} ( t ) = \frac{1}{D} {\sum }_{i = 1}^{p} {a}_{ij} {F}_{i} ( t )$$

With aᵢⱼ=1 for a dark pixel and aᵢⱼ=−1 for a bright pixel. The row and column signals are now defined by F and D:

$$F = \frac{1}{2 \sqrt{p}} \sqrt{\begin{matrix}- 2 {MV}_{probe}^{2} + ( M + N ) ( {V}_{sat}^{2} + {V}_{th}^{2} ) \\ - \frac{1}{2} \sqrt{\begin{matrix}- 4 {N ( M + N )}^{2} {( {V}_{sat}^{2} - {V}_{th}^{2} )}^{2} + \\ {( - 4 {MV}_{probe}^{2} + 2 ( M + N ) ( {V}_{sat}^{2} + {V}_{th}^{2} ) )}^{2}\end{matrix}}\end{matrix}}$$

$$D = \frac{4 {pF}^{2}}{( N + M ) ( {V}_{sat}^{2} - {V}_{th}^{2} )}$$

By way of example FIG. 8 shows a timing diagram for this kind of addressing.

Of course the invention is not limited to the embodiments as shown. As mentioned in the introduction the control circuits 18, 19 and/or the block 25 may impose voltages on the electrodes 2, 3 to make the display vibrate, either or not in the acoustic region (singing display).

Other input functions may be used in stead of touching such as a microphone function.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A method of converting of a first set of initial segments of an image into a second set of updated segments of the image, the method comprising iterative updates of intermediate segments being derived from respective initial segments, a particular update comprising determining whether a particular pixel being located at a border between a first one of the intermediate segments, and a second one of the intermediate segments, should be moved from the first one of the intermediate segments to the second one of the intermediate segments, on basis of a pixel value of the particular pixel, on basis of a first parameter of the first one of the intermediate segments and on basis of a second parameter of the second one of the intermediate segments, characterized in that first a number of iterative updates are performed for pixels of a first two-dimensional block of pixels of the image and after that the number of iterative updates are performed for pixels of a second two-dimensional block of pixels of the image.

2. A method of converting as claimed in claim 1, characterized in that the first parameter corresponds to a mean color value of the first intermediate segment, the second parameter corresponds to a mean color value of the second intermediate segment and the pixel value of the particular pixel represents the color value of the particular pixel.

3. A method of converting as claimed in claim 1, characterized in that the particular update is based on a regularization term depending on the shape of the first one of the intermediate segments, the regularization term being computed on basis of a first group of pixels of the first two-dimensional block of pixels.

4. A method of converting as claimed in claim 1, characterized in that a first sequence of the number of iterative updates are performed in a row-by-row scanning within the first block of pixels and a second sequence of the number of iterative updates are performed in a column-by-column scanning within the first block of pixels.

5. A method of converting as claimed in claim 1, characterized in that the first two-dimensional block of pixels is located adjacent to the second two-dimensional block of pixels.

6. A method of converting as claimed in claim 1, characterized in that the regularization term is computed on basis of the first group of pixels of the first two-dimensional block of pixels and a second group of pixels of the second two-dimensional block of pixels.

7. A conversion unit for converting a first set of initial segments of an image into a second set of updated segments of the image, the conversion unit being arranged to perform iterative updates of intermediate segments being derived from respective initial segments, a particular update comprising determining whether a particular pixel being located at a border between a first one of the intermediate segments, and a second one of the intermediate segments, should be moved from the first one of the intermediate segments to the second one of the intermediate segments, on basis of a pixel value of the particular pixel, on basis of a first parameter of the first one of the intermediate segments and on basis of a second parameter of the second one of the intermediate segments, characterized in that the conversion unit comprises computation means for performing first a number of iterative updates for pixels of a first two-dimensional block of pixels of the image and for, after that, performing the number of iterative updates for pixels of a second two-dimensional block of pixels of the image.

8. An image processing apparatus, comprising:
receiving means for receiving a signal representing an image;
a segmentation unit for determining a first set of initial segments of the image;
a conversion unit for converting the first set of initial segments into a second set of updated segments, the conversion unit as claimed in claim 7; and
an image processing unit for processing the image on basis of the second set of updated segments.

9. An image processing apparatus as claimed in claim 8, whereby the image processing unit is designed to perform video compression.
